(19) United States
(12) Patent Application Publication
(10) Pub. No.: US 2006/0209363 A1
(43) Pub. Date: Sep. 21, 2006

(54) Scanner system and method for detecting corrected portion in scanned object

(75) Inventors: Yoshiko Suenaga, Kanagawa-ken (JP); Hiroki Miyachi, Kanagawa-ken (JP); Kouichi Mase, Chiba-Ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/289,951

(22) Filed: Nov. 29, 2005

(30) Foreign Application Priority Data
Mar. 16, 2005 (JP) 2005-075784

(51) Int. Cl. H04N 1/04

(52) U.S. Cl. 358/474; 358/1.15

(57) ABSTRACT

The present invention provides a scanner system and a method for detecting a corrected portion in a scanned object, the system and method being capable of detecting a portion corrected with correction fluid in a scanned original. The scanner system includes: an operation unit for accepting user input operations, such as a detection mode setting operation and a scan start requesting operation; a display unit for displaying an indication, such as an error indication or the result of detection, to show information to a user in a visual form; a read unit for converting information written on a paper original into image information; a corrected portion detection unit for detecting a corrected portion (corrected region) on the basis of the image information; a job management unit for managing the obtained image information and the result of detection; and a control unit for controlling the respective units.

### BACKGROUND OF THE INVENTION

1. Field of the Invention

The present invention relates to a technique of extracting text as image information and, more particularly, to a scanner system and a method for detecting a corrected portion in a scanned object, the system and method being capable of detecting a portion corrected with correction fluid in text upon scanning the text.

2. Description of the Related Art

Japanese Unexamined Patent Application Publication No. 7-287738 discloses a scanner system and a method for detecting a corrected portion in a scanned object. According to the system and method, a scanner scans an original paper document and a corrected paper document to obtain images (electronic data) and the images are stored as electronic documents. The two electronic documents are compared to each other to obtain the difference therebetween. The difference between the original and corrected documents is displayed.

According to the above-mentioned system and method, a paper document which is not permitted to be corrected by original (document) correction means, such as correction fluid, a correction tape, or other similar means, (hereinafter, for the purpose of simplifying, referred to as correction fluid) can be scanned through the scanner and be then stored as an image (electronic data).

When the scanner scans a document corrected with correction fluid, a blank serving as an original white region in the document and a portion corrected with correction fluid are recognized as white regions. In some cases, the blank and the corrected portion cannot be distinguished from each other. Accordingly, in the event that a paper document including at least one portion corrected with correction fluid, which is not permitted to be corrected with correction fluid is converted into an electronic document and then the electronic document is stored, the reliability of the electric document cannot be assured. Unfortunately, this situation may cause a bottleneck in developing electronic documentation.

According to this system and method, the above-mentioned two documents can be compared to each other. However, even when the documents cannot be compared to each other because an original document has been lost, it is actually impossible to determine whether the document has been corrected with correction fluid.

### SUMMARY OF THE INVENTION

The present invention is made to overcome the above-mentioned disadvantages. Accordingly, it is an object of the present invention to provide a scanner system and a method for detecting a corrected portion in a scanned object, the system and method being capable of detecting a portion corrected with correction fluid in a scanned original.

According to an aspect of the present invention, there is provided a scanner system including: an operation unit for accepting an input operation; a display unit for showing information in a visual form; a read unit for obtaining scan configuration information including conditions for scanning to convert information written in an original into image information in a detection mode when the detection mode is switched on; a corrected portion detection unit for obtaining correction criteria configuration information used to determine whether the original includes a corrected portion, detecting on the basis of the image information and the obtained correction criteria configuration information whether each page of the original includes a portion corrected by an original correcting material, and generating detection result information regarding the result of detection; a job management unit for managing the image information and the detection result information as electronic information such that the managed information is readable; and a control unit for controlling the operation unit, the display unit, the read unit, the corrected portion detection unit, and the job management unit.

According to another aspect of the present invention, there is provided a method for detecting a corrected portion in a scanned object, wherein parameters for scanning are set such that the gray scale of the background of the object is closer to black, the object is scanned to obtain image information, and gray scales are detected based on the image information to distinguish the background from a corrected portion in the object.

According to further aspect of the present invention, there is provided a method for detecting a corrected portion in an scanned object, the method including the steps of: scanning the object in a detection mode; determining, on the basis of image information obtained by scanning in the detection mode and correction criteria configuration information, whether each page of the scanned object includes a corrected portion; and issuing a warning message when at least one corrected portion is detected.

According to the system and method of the present invention, a portion corrected with correction fluid or the like can be detected in a scanned original. As compared to the conventional scanner system and corrected portion detecting method, the advantage of preventing a user from intentionally or accidentally performing the scanning of a document corrected with correction fluid can be improved.

### BRIEF DESCRIPTION OF THE DRAWINGS

FIG. 1 is a schematic block diagram of the basic functional structure of a scanner system according to an embodiment of the present invention; and

FIG. 2 is a flowchart of a corrected portion detecting process executed by the scanner system according to the embodiment of the present invention.

### DESCRIPTION OF THE PREFERRED EMBODIMENTS

A scanner system and a method for detecting a corrected portion in a scanned object according to the present invention will now be described with reference to the accompanying drawings.

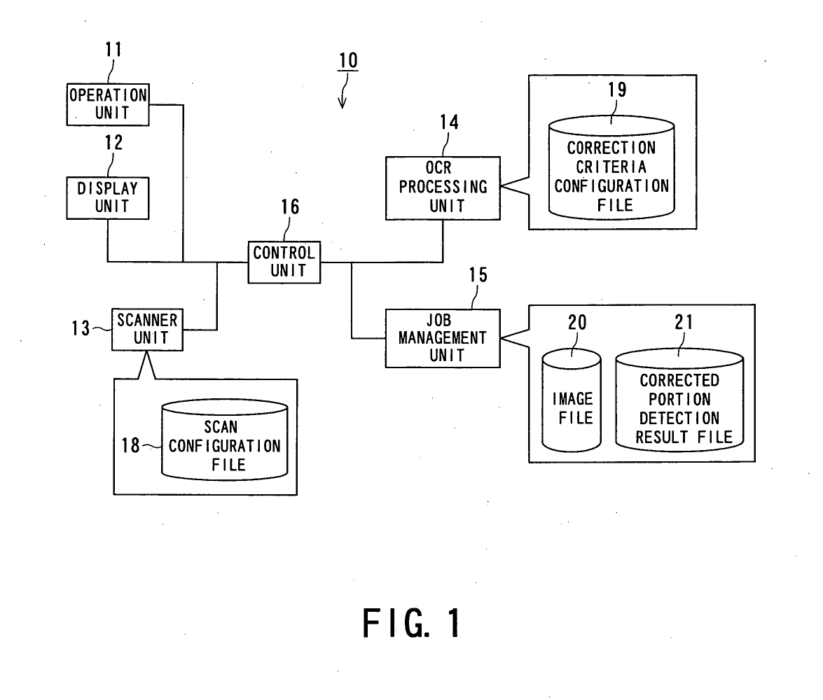

FIG. 1 is a schematic block diagram of the basic fundamental structure of a scanner system 10 according to an embodiment of the present invention.

Referring to FIG. 1, the scanner system 10 includes: an operation unit 11 for accepting user input operations, such as a detection mode setting operation and a scan start requesting operation; a display unit 12 for displaying an indication, such as an error indication or an indication about the result of detection, to show information to a user in a visual form; a read unit 13 for converting information written on an original (the surface of a sheet) into image information; a corrected portion detection unit 14 for detecting on the basis of the image information whether each page of the read original includes a corrected portion (corrected region); a job management unit 15 for managing the obtained image information and the result of detection; and a control unit 16 for controlling the operation unit 11, the display unit 12, the read unit 13, the corrected portion detection unit 14 and the job management unit 15.

The operation unit 11 has a function of accepting user input operations, such as the detection mode setting operation, the scan start requesting operation, or the like. Information regarding the details of the operation accepted by the operation unit 11 is transmitted as input operation information to the control unit 16.

The display unit 12 has a function of showing information provided by the scanner system 10 (more specifically, the control unit 16) to the user in a visual form. When the display unit 12 receives display information from the control unit 16, the display unit 12 displays an indication based on the display information. The display unit 12 displays information regarding the result of detecting a corrected portion.

Note that the operation unit 11 and the display unit 12 are not necessarily arranged as separate components in the actual system. The units 11 and 12 may be provided as an integrated operation/display unit.

The read unit 13 has a function of reading an original including at least one sheet (i.e., one or more pages) and converting the original into image information, i.e., a scanning function. The read unit 13 obtains scan configuration information regarding conditions for scanning, i.e., set parameters, such as the type of an original, gray scales, a background correction value, and sharpness. The scan configuration information is recorded as electronic information, e.g., a scan configuration file 18. Therefore, the read unit 13 is possible to obtain the scan configuration information by reading (referring to) the scan configuration file 18.

The scan configuration information includes at least configuration information used in normal scanning (hereinafter, referred to as a normal mode) and configuration information used in scanning in order to detect a corrected original (hereinafter, referred to as a detection mode). Parameter values included in the configuration information for the normal mode are different from those in the configuration information for the detection mode. The scan configuration information also includes mode information indicating whether the detection mode is switched on or off.

In addition, the read unit 13 can recognize the state of the detection mode, i.e., whether the detection mode is switched on or off, and scan on the basis of the recognized state. In other words, when the detection mode is switched on, the read unit 13 scans in the detection mode. When the detection mode is switched off, the read unit 13 scans in the normal mode.

Note that the read unit 13 does not necessarily obtain the scan configuration information from the scan configuration file 18. Instead of obtaining the scan configuration information from the scan configuration file 18, the read unit 13 may receive information regarding parameters from the operation unit 11.

When the detection mode is selected, the read unit 13 scans in accordance with the scan configuration information, which is used to detect a corrected original, to generate image information. In the detection mode, image information is generated such that the background of a scanned original is closer to black than that in the normal mode. In the event that a background portion is compared to a portion corrected with correction fluid, the colors of the respective portions seem to be similar to white on the original. In image information obtained in the detection mode, however, the color of the background portion is close to black and that of the corrected portion is close to white. The portions are obviously different from each other. The read unit 13 transmits image information of the scanned original to the control unit 16.

The corrected portion detection unit 14 has a function (hereinafter, referred to as a corrected portion detecting function) of detecting on the basis of the image information obtained through the read unit 13 whether each page of the scanned original includes a corrected region or portion corrected by original correction means such as correction fluid, a correction tape, or similar means. Note that the original correction means, for the purpose of simplifying, will be referred to as correction fluid in the following description. Further, note that correcting a portion in an original with correction fluid will be referred to manual correction in the following description.

The corrected portion detection unit 14 can distinguish the background from a corrected portion in image information, which is obtained through the read unit 13 and is then transmitted from the control unit 16, by using the corrected portion detecting function. To accurately distinguish the background from a corrected portion through the corrected portion detection unit 14, the read unit 13 has to convert an original into image information in the detection mode. The reason resides in that the corrected portion detection unit 14 detects a manually corrected portion on the basis of the difference in gray scale between the background and the corrected portion.

To determine whether a corrected portion is detected or not, the corrected portion detection unit 14 refers to information (correction criteria configuration information) including preset criteria which are used to determine whether an original has been corrected, i.e., whether a region with a relatively high gray scale is larger than a predetermined area or whether a linear continuous region with a relatively high gray scale is longer than a predetermined length. The correction criteria configuration information is stored as electronic information, e.g., a correction criteria configuration file 19, in the corrected portion detection unit 14.

The corrected portion detection unit 14 transmits information regarding the result of detecting a corrected portion (corrected region) to the control unit 16.

The job management unit 15 has a function of managing obtained image information and the result of detection. In other words, the job management unit 15 can store image information obtained through the read unit 13 as electronic information, e.g., an image file 20, and information regarding the result of detection, i.e., a corrected portion detected by the corrected portion detection unit 14 as electronic information, e.g., a corrected portion detection result file 21 in a data recording area provided in the job management unit 15 or an arbitrary external data recording area. The job management unit 15 can read information from the recording area. The job management unit 15 receives image information and information regarding the detection result from the control unit 16.

The control unit 16 has a function of controlling the operation unit 11, the display unit 12, the read unit 13, the corrected portion detection unit 14, and the job management unit 15. The control unit 16 can transmit and receive information to/from the respective units 11 to 15.

More specifically, the control unit 16 receives input operation information regarding the details of a user input operation from the operation unit 11 and controls the display unit 12, the read unit 13, the corrected portion detection unit 14, and the job management unit 15 in accordance with the details of the input operation. The control unit 16 allows at least one of the units 11 to 15 to execute necessary processing on the basis of the details of the input operation.

In addition, the control unit 16 receives image information, obtained by scanning an original through the read unit 13, from the read unit 13 and transmits the image information to the job management unit 15. The job management unit 15 manages the received image information.

Further, the control unit 16 receives correction result information regarding the result of detecting a corrected portion (corrected region) through the corrected portion detection unit 14 and then transmits the received information to the job management unit 15. The job management unit 15 manages the received correction result information. In the event that at least one corrected portion is detected, the control unit 16 generates display information to display a warning message indicating that the corrected portion is detected. Then, the control unit 16 transmits the display information to the display unit 12.

Since the scanner system 10 with the above-mentioned structure includes the read unit 13 capable of scanning in the detection mode and the corrected portion detection unit 14 capable of detecting a corrected portion (corrected region) based on image information obtained through the read unit 13, the corrected portion detection unit 14 can detect the gray scales of white portions (background and a corrected portion) in a paper document on the basis of image information obtained in the detection mode. Thus, the scanner system 10 can detect a manually corrected portion, i.e., a portion corrected with correction fluid.

When at least one corrected portion is detected, a warning message is issued. As compared to the conventional scanner system, the advantage of preventing the user from intentionally or accidentally performing the scanning of a manually corrected document can be improved. Further, when the scanner system is set so that scanning is disabled upon detecting a corrected portion, the advantage of prohibiting the user from intentionally or accidentally performing the scanning of a manually corrected document can also be improved.

In addition, since a warning message is issued upon detecting a corrected portion, it turns out that a document has been scanned with at least user's consent.

The scanner system 10 may further include an alarm unit (not shown). When at least one corrected portion is detected, the control unit 16 can allow the alarm unit to output a beep or voice indicating that the corrected portion is detected.

Further, the scanner system 10 may be constructed such that the display unit 12 displays a warning message and an indication to prompt the user to determine whether to forcibly execute the scanning. Accordingly, when the operation unit 11 accepts a user input operation indicating the user wants to execute the scanning, the scanning can be forcibly carried out.

The scanner system 10 may further include certification device having a certifying function using a password so that a predetermined user can switch the detection mode on or off and change scan configuration information.

In addition, the scanner system 10 can be designed such that the job management unit 15 stores information units, each regarding the date and time of scanning and the result of detecting a corrected portion in each page of a scanned original, as logs (electronic information) corresponding to the predetermined number or amount of data.

In the event that the user wants to forcibly scan a document in which at least one corrected portion is detected, the scanner system 10 can also be configured such that the read unit 13 does not start scanning until the user enters their identification information such as user's name, user ID or the like.

When scanning is forcibly executed, the job management unit 15 can store information (hereinafter, referred to as scanning information), i.e., at least either user identification information or a log (information regarding the scanning date and time and the result of detecting a corrected portion in each page), as electronic information, e.g., a file in addition to image information.

The scanner system 10 may further include electronic signature assigning device for assigning an electronic signature obtained from an external certificate authority to electronic information. According to this scanner system 10, since the electronic signature assigning device can assign an electronic signature to each of a scanned image and scanning information regarding the scanned image, the scanner system 10 can also ensure that the scanning information is not tampered with.

The corrected portion detecting method according to the present invention will now be described. The corrected portion detecting method is a method for detecting a corrected portion in a scanned object.

The method according to the present invention is realized by executing a corrected portion detecting process through the scanner system 10.

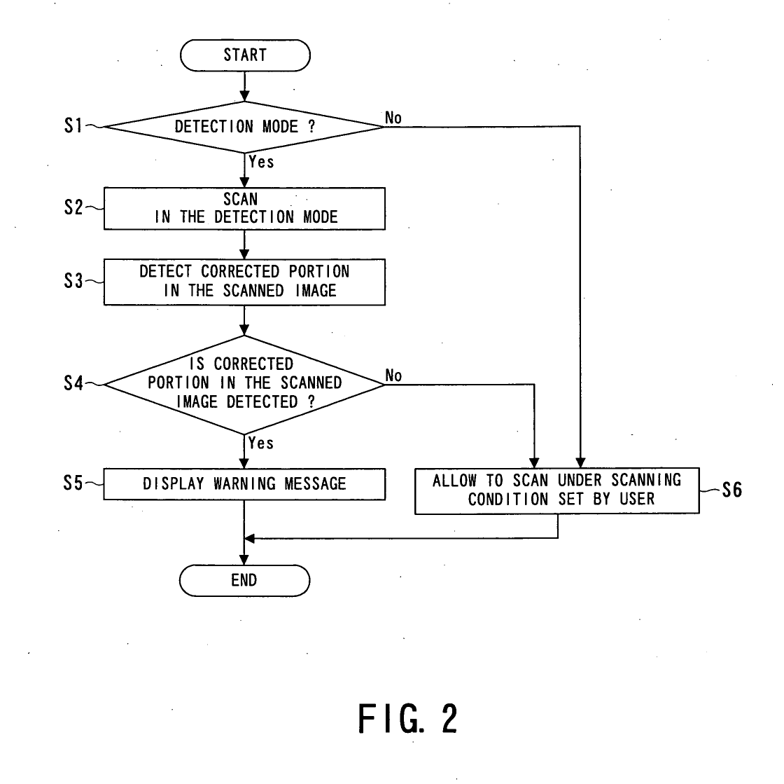

FIG. 2 is a flowchart of the corrected portion detecting process executed by the scanner system 10.

The corrected portion detecting process includes: a detection mode determining step (step S1) of determining whether the detection mode is switched on; a detection mode scanning step (step S2) of scanning an original in the detection mode; a corrected portion detecting step (step S3) of detecting, on the basis of image information obtained in the detection mode scanning step and correction criteria configuration information, whether each page of the scanned original includes a corrected portion; a warning step (step S5) of issuing a warning message when at least one corrected portion is detected in the corrected portion detecting step (YES in step S4); and a scan permitting step (step S6) of permitting to scan an image when the detection mode is switched off (NO in step S1) or when a corrected portion is not detected in the corrected portion detecting step (NO in step S4).

When the operation unit 11 receives a scan execution request from the user, the corrected portion detecting process starts (START).

In the detection mode determining step (step S1), the read unit 13 determines whether the detection mode is switched on or not. If the detection mode is switched on (YES in step S1), the process proceeds to step S2.

In step S2, i.e., the detection mode scanning step, the read unit 13 scans an original, serving as an object to be processed, in the detection mode. When the read unit 13 scans the original and converts a captured image of the original into image information, the detection mode scanning step completes. Then, the process proceeds to step S3.

In step S3, i.e., the corrected portion detecting step, the corrected portion detection unit 14 detects, on the basis of the image information obtained in the detection mode scanning step, whether each page of the scanned original includes a manually corrected portion, i.e., a portion corrected with correction fluid or not.

In the event that the corrected portion detection unit 14 detects at least one manually corrected portion in the scanned image (YES in step S4), the corrected portion detection unit 14 transmits detection result information indicating that the manually correction portion is detected to the control unit 16. Then, the process proceeds to step S5.

In step S5, i.e., the warning step, upon receiving the detection result information from the corrected portion detection unit 14, the control unit 16 generates display information to display a warning message and then transmits the generated display information to the display unit 12. When receiving the display information from the control unit 16, the display unit 12 displays a warning message based on the display information. When the display unit 12 displays the warning message, the warning step completes. Then, the corrected portion detecting process completes (END).

On the other hand, if the detection mode is switched off in the detection mode determining step (NO in step S1), the process proceeds to step S6. In step S6, i.e., the scan permitting step, the read unit 13 is permitted to scan a region, where a manually corrected portion is not detected, in the normal mode or under a condition specified by parameters set by the user. When the read unit 13 is allowed to scan a region where a manually corrected portion is not detected in the normal mode, step S6 completes. Then, the corrected portion detecting process completes (END).

If a manually corrected portion is not detected in the corrected portion detecting step (NO in step S4), the process proceeds to step S6.

According to the corrected portion detecting method of the present invention, the corrected portion detecting method includes the detection mode scanning step, the corrected portion detecting step, the warning step, and the scan permitting step. Therefore, in the event that the detection mode is switched on, in the corrected portion detecting step, a manually corrected portion, i.e., a portion corrected with correction fluid can be detected in a scanned original, serving as a scanned object, on the basis of image information obtained in the detection mode scanning step.

In addition, when at least one manually corrected portion is detected in the corrected portion detecting step, the warning step is executed. Thus, when a manually corrected portion is detected, a warning can be given to the user. Further, if a manually corrected portion is not detected in the corrected portion detecting step, normal scanning is permitted in the scan permitting step. As compared to the conventional method for detecting a corrected portion in a scanned object, the advantage of preventing or prohibiting the user from intentionally or accidentally executing the scanning of a manually corrected document can be improved.

As mentioned above, according to the scanner system and the corrected portion detecting method of the present invention, the gray scales of white portions (background and a corrected portion) in a paper original can be detected from image information obtained by scanning the original in the detection mode. Thus, a portion corrected with correction fluid can be detected in the scanned original, serving as a scanned object.

As compared to the conventional scanner system and corrected portion detecting method, the advantage of preventing the user from intentionally or accidentally performing the scanning of a document corrected with correction fluid can be improved.

What is claimed is:

1. A scanner system comprising:
an operation unit for accepting an input operation;
a display unit for showing information in a visual form;
a read unit for obtaining scan configuration information including conditions for scanning to convert information written in an original into image information in a detection mode when the detection mode is switched on;
a corrected portion detection unit for obtaining correction criteria configuration information used to determine whether the original includes a corrected portion, detecting on the basis of the image information and the obtained correction criteria configuration information whether each page of the original includes a portion corrected by original correction means, and generating detection result information regarding the result of detection;
a job management unit for managing the image information and the detection result information as electronic information such that the managed information is readable; and
a control unit for controlling the operation unit, the display unit, the read unit, the corrected portion detection unit, and the job management unit.

2. The system according to claim 1, wherein in case of detecting that the original includes at least one corrected portion, said corrected portion detection unit allows the display unit to display the detection result information and information to make an inquiry about whether to scan.

3. The system according to claim 1, wherein in case of detecting that the original includes at least one corrected portion, said corrected portion detection unit prompts a user to enter identification information serving as a condition to scan through the read unit.

4. The system according to claim 1, wherein in case of detecting that the original includes at least one corrected portion, said corrected portion detection unit allows the display unit to display the detection result information and information indicating that scanning is prohibited, and said read unit then stops scanning.

5. The system according to claim 1, further comprising an alarm unit, wherein said alarm unit is driven when the corrected portion detection unit detects that the original includes at least one corrected portion.

6. The system according to claim 1, further comprising a certification device, wherein said certification device allows to switch the detection mode between on and off in case of certificating a user.

7. The system according to claim 1, wherein said job management unit stores information units, each regarding the scanning date and time and the result of detecting a corrected portion in each page of the corresponding scanned original, as logs within a range up to at least either the predetermined number of logs or the predetermined amount of data.

8. The system according to claim 1, further comprising:
an electronic signature assigning device for assigning an electronic signature obtained from a certificate authority to each file; and
a communication interface communicating with the certificate authority, wherein said electronic signature assigning device assigns an electronic signature, obtained from the certificate authority through the communication interface, to each log and the corresponding image information.

9. A method for detecting a corrected portion in a scanned object, wherein parameters for scanning are set such that the gray scale of the background of the object is closer to black, the object is scanned to obtain image information, and gray scales are detected based on the image information to distinguish the background from a corrected portion in the object.

10. The method according to claim 9, wherein
said background of the scanned object is distinguished from the corrected portion in the object on the basis of the image information and correction criteria configuration information, and said correction criteria configuration information includes information regarding at least either a threshold value of the area of a region with a relatively high gray scale or a threshold value of the length of a linear continuous region with a relatively high gray scale.

11. A method for detecting a corrected portion in a scanned object, the method comprising the steps of:
scanning the object in a detection mode;
determining, on the basis of image information obtained by scanning in the detection mode and correction criteria configuration information, whether each page of the scanned object includes a corrected portion; and
issuing a warning message when at least one corrected portion is detected.
